(19) United States
(12) Patent Application Publication
(10) Pub. No.: US 2015/0332188 A1
(43) Pub. Date: Nov. 19, 2015

(54) Managing Crowdsourcing Environments

(71) Applicant: CROWD COMPUTING SYSTEMS, INC., New York, NY (US)

(72) Inventors: Max Yankelevich, Monroe Township, NJ (US); Andrii Volkov, North Brunswick, NJ (US)

(21) Appl. No.: 14/809,100

(22) Filed: Jul. 24, 2015

Related U.S. Application Data
(63) Continuation of application No. 13/360,940, filed on Jan. 30, 2012.

(51) Int. Cl. G06Q 10/06; G06Q 30/02

(52) U.S. Cl. CPC G06Q 10/06311; G06Q 30/0208; G06Q 50/01

(57) ABSTRACT

One or more embodiments manage web-based crowdsourcing of tasks to an unrelated group of workers. An information set associated with a task to be crowdsourced is received from at least one customer that is associated with the task. This information set comprises at least a description of the task, a reward to be provided for completion of the task, and at least one adjudication rule for accepting a task result. At least one advertising campaign for the task is created based on the information set. The advertising campaign is published for access by a set of one or more worker systems. At least one task result associated with the task is received from at least one of the set of one or more of the worker systems. The task result is compared against the rule. Task results are received and compared to the adjudication rule until the rule is satisfied.

### PRIORITY

This application is a continuation under 35 U.S.C. §120 of U.S. patent application Ser. No. 13/360,940, filed 30 Jan. 2012.

### BACKGROUND

Embodiments of the present invention generally relate to crowdsourcing, and more particularly relate to managing and providing crowdsourcing environments.

Crowdsourcing has recently gained increased popularity within various industries. Crowdsourcing refers to the act of delegating (sourcing) tasks by an entity (crowdsourcer) to a group of people or community (crowd) through an open call. Individuals (workers) within the crowd are usually rewarded for completing a task. Conventional crowdsourcing systems generally require a large amount of manual intervention by the entity that is sourcing the tasks. For example, the entity is generally required to manually manage workers and their output, the rewarding of workers, etc. This manual intervention can be very time consuming and costly to the entity.

### SUMMARY OF PARTICULAR EMBODIMENTS

In one embodiment, a method for managing web-based crowdsourcing of tasks to an unrelated group of workers is disclosed. An information set associated with a task to be crowdsourced is received from at least one customer that is associated with the task. This information set comprises at least description of the task, a reward to be provided for completion of the task, and at least one adjudication rule for accepting a task result provided by workers participating in the task. At least one advertising campaign for the task is created based on the information set. The advertising campaign is published for access by a set of one or more worker systems. Each of the one or more worker systems is used by at least one worker. At least one task result associated with the task is received from at least one of the set of one or more of the worker systems. The task result is compared against the adjudication rule. Task results are received and compared to the adjudication rule until the adjudication rule is satisfied.

In another embodiment, an information processing system for managing web-based crowdsourcing of tasks to an unrelated group of workers is disclosed. The information processing system comprises a memory and a processor that is communicatively coupled to the memory. A crowdsourcing manager is communicatively coupled to the memory and the processor. The crowdsourcing manager is configured to perform a method comprising receiving an information set associated with a task to be crowdsourced from at least one customer that is associated with the task. This information set comprises at least description of the task, a reward to be provided for completion of the task, and at least one adjudication rule for accepting a task result provided by workers participating in the task. At least one advertising campaign for the task is created based on the information set. The advertising campaign is published for access by a set of one or more worker systems. Each of the one or more worker systems is used by at least one worker. At least one task result associated with the task is received from at least one of the set of one or more of the worker systems. The task result is compared against the adjudication rule. Task results are received and compared to the adjudication rule until the adjudication rule is satisfied.

In yet another embodiment, a computer program product for managing web-based crowdsourcing of tasks to an unrelated group of workers is disclosed. The computer program product comprises a storage medium readable by a processing circuit and storing instructions for execution by the processing circuit for performing a method. The method comprises receiving an information set associated with a task to be crowdsourced from at least one customer that is associated with the task. This information set comprises at least description of the task, a reward to be provided for completion of the task, and at least one adjudication rule for accepting a task result provided by workers participating in the task. At least one advertising campaign for the task is created based on the information set. The advertising campaign is published for access by a set of one or more worker systems. Each of the one or more worker systems is used by at least one worker. At least one task result associated with the task is received from at least one of the set of one or more of the worker systems. The task result is compared against the adjudication rule. Task results are received and compared to the adjudication rule until the adjudication rule is satisfied.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 is a block diagram illustrating a detailed view of a crowdsourcing manager according to one embodiment of the present invention;

FIG. 3 is a table illustrating one example of task data according to one embodiment of the present invention;

FIG. 4 is a table illustrating one example of worker data according to one embodiment of the present invention;

FIG. 5 is a table illustrating one example of customer data according to one embodiment of the present invention;

FIG. 6 shows one example of a user interface comprising menu items for a customer of a crowdsourcing environment according to one embodiment of the present invention;

FIG. 7 shows one example of a user interface comprising a display area for a customer of a crowdsourcing environment according to one embodiment of the present invention;

FIG. 8 shows one example of a user interface comprising task associated with a customer of a crowdsourcing environment according to one embodiment of the present invention;

FIG. 9 shows one example of a template for creating a task for a crowdsourcing environment according to one embodiment of the present invention;

FIG. 10 shows one example of a template for providing results/answers for a task for selection by a worker in a crowdsourcing environment according to one embodiment of the present invention;

FIG. 11 shows one example of a template for creating an adjudication rule for a task in a crowdsourcing environment according to one embodiment of the present invention;

FIG. 12 shows one example of a template for selecting notification templates for a task in a crowdsourcing environment according to one embodiment of the present invention;

FIG. 13 shows one example of a template for entering advanced options for a task in a crowdsourcing environment according to one embodiment of the present invention;

FIG. 14 shows one example of a template for creating a task workflow in a crowdsourcing environment according to one embodiment of the present invention;

FIG. 15 shows one example of a report displaying summary information for a task workflow in a crowdsourcing environment according to one embodiment of the present invention;

FIG. 16 shows one example of a report displaying task result information in a crowdsourcing environment according to one embodiment of the present invention;

FIG. 17 shows one example of a report displaying worker information in a crowdsourcing environment according to one embodiment of the present invention;

FIG. 18 is a transactional diagram illustrating one example of an overall process for managing a crowdsourcing environment according to one embodiment of the present invention;

FIG. 19 shows one example of a template presented to a user for participating in a task of a crowdsourcing environment according to one embodiment of the present invention;

FIG. 20 is an operational flow diagram illustrating one example of an overall process for managing a crowdsourcing environment according to one embodiment of the present invention; and

FIG. 21 illustrates one example of an information processing system according to one embodiment of the present invention.

### DESCRIPTION OF EXAMPLE EMBODIMENTS

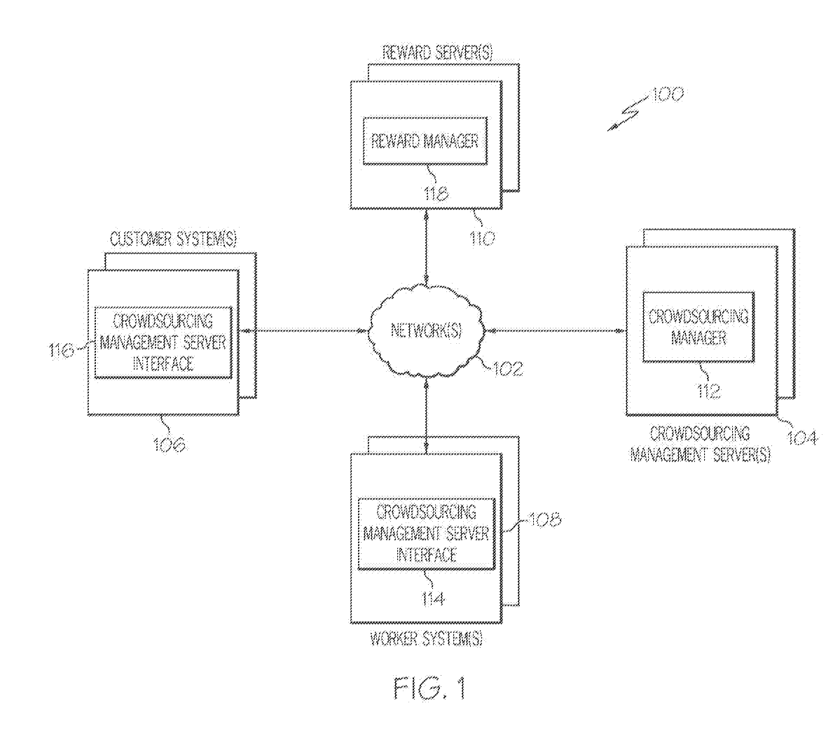

FIG. 1 shows one example of an operating environment 100 according to one embodiment of the present invention. The operating environment 100 comprises one or more networks 102 that, in one embodiment, can include wide area networks, local area networks, wireless networks, and/or the like. It should be noted that the network 102 comprises various networking hardware (and software) components such as gateways, routers, firewalls, etc., which are not shown for simplicity. The environment 100 includes a plurality of information processing systems 104, 106, 108, 110 that are communicatively coupled to the network(s) 102. The information processing systems 104, 106, 108, 110 include one or more crowdsourcing management servers 104, one or more customer systems 106, one or more worker systems 108, and one or more reward management servers 110 (or payment systems 110). The environment 100 can also include additional systems such as admin systems, database systems, storage systems, etc., which are not shown in FIG. 1. Users of the worker systems 106 and customer systems interact with the crowdsourcing management server 104 via an interface 114, 116 or programmatically via an API(s).

Throughout this discussion a “customer” refers to an entity that submits/creates a task to the crowdsourcing management server 104 to be sourced (e.g., published, broadcasted, advertised, etc.) to a set of one or more workers. This set of one or more workers can be referred to as a “crowd”. Workers can be comprised of a cohesive or disparate group of individuals. A “task” (also referred to as a “problem”) comprises one or more actions to be performed by the workers. The result of the workers performing these requested actions can be referred to as the “output” or “result” of the task, the “work product” of a worker”, or the “solution” to the problem. A “project” refers to a plurality of related tasks.

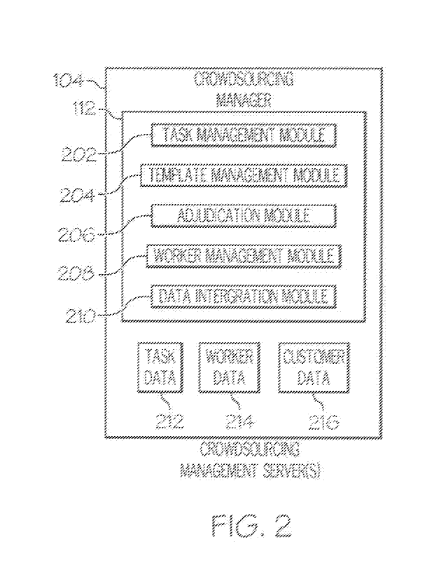

The crowdsourcing management server 104 comprises a crowdsourcing manager 112. The customer and worker systems 106, 108 comprise the interfaces 114, 116 discussed above. The reward server 110 comprises a reward manager 118 for managing the awarding of rewards to workers. The crowdsourcing manager 112 of the server 104 manages a crowdsourcing environment provided by the server 104 and also any interactions between customers/workers and the crowdsourcing environment. This crowdsourcing environment allows customers to manage tasks and allows workers to participate in tasks. The crowdsourcing manager 112, in one embodiment, comprises a task management module 202, a template management module 204, an adjudication module 206, a worker management module 208, and a data integration module 210, as shown in FIG. 2.

The task management module 202 manages tasks and generates tasks from information entered by a customer in one or more templates provided by the template management module 204. The task management module 202 maintains information associated with tasks as task data 212. This task data 212 can be stored within the crowdsourcing management server 104 and/or on one or systems coupled to the server 104. The template management module 204 provides various templates or screens for a customer or worker to interact with when accessing the crowdsourcing management server 104. The adjudication module 206 manages the results provided/submitted by a worker for a task. The adjudication module 206 utilizes one or more adjudication rules or acceptance criteria to ensure that the best results of a task are identified and/or to provide a degree of confidence in the correctness of a result.

The worker management module 208 manages the workers associated with the crowdsourcing environment of the crowdsourcing management server 104. The worker management module 208 maintains information associated with workers as worker data 214. This worker data 214 can be stored within the crowdsourcing management server 104 and/or on one or more systems coupled to the server 104. The worker management module 208, in one embodiment, uses the worker data 214 for, among other things, determining which set of workers to present a given task to. The data integration module 210 interfaces with one or more customer servers (not shown) to provide the data to a worker upon which the task is to be performed. In addition to the above, the crowdsourcing management server 104 also comprises and maintains customer data 216. The customer data 216 comprises information associated with each customer that has registered with the crowdsourcing management server 104. The crowdsourcing manager 112 and its components are discussed in greater detail below.

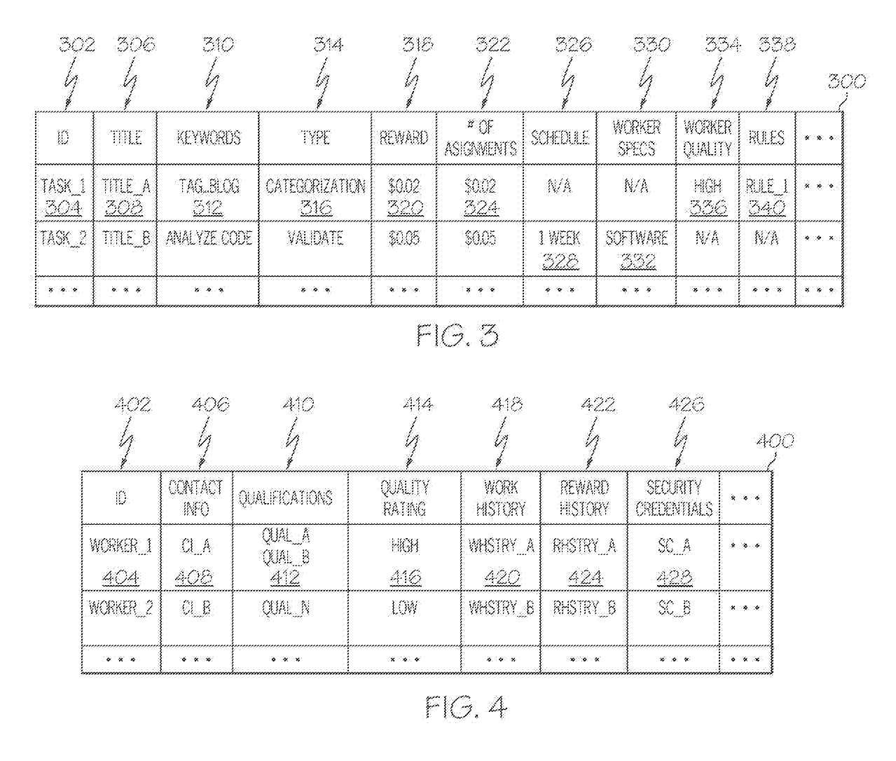

FIG. 3 shows one example of the task data 212 maintained by the task management module 202. It should be noted that although FIG. 3 shows a single table 300 comprising records (i.e., rows) for each task a separate record/file can be stored for each task as well. Also, embodiments of the present invention are not limited to a table and other structures for storing data are applicable as well. Even further, one or more columns can be added and/or removed from the table 300 as well. The table 300 in FIG. 3 comprises a plurality of columns and rows, where each row is associated with a single task. A first column 302, entitled “ID”, comprises entries that uniquely identify each task associated with the crowdsourcing environment. For example, a first entry 304 under this column 302 identifies a first task with the unique identifier of “Task_1”. The task ID can be automatically assigned by the task management module 202 upon creation of a task.

A second column 306, entitled “Title”, comprises entries 308 that provide the title of the corresponding task. This title can be manually entered by the customer during the task creation/submission process or automatically generated by the task management module 202. It should be noted that the table 300 can also include an additional column (not shown) for providing a more detailed description of the task. A third column 310, entitled “Keywords”, comprises entries 312 that comprise optional keywords for the corresponding task. These keywords allow the customer or worker to search for tasks being maintained by the server 104. It should be noted that tasks can be search for by the customer or worker based on any of the information shown (and not shown) in FIG. 3.

Keywords can be manually entered by the customer during the task creation/submission or automatically generated by the task management module 202. The crowdsourcing manager 112 can use the keywords to determine which tasks to publish/advertise to which workers. For example, a worker may include in his/her profile that he/she only wants to participate in tasks associated with a given type, category, keyword, technical area, etc. The crowdsourcing manager 112 can then match tasks to specific workers based on the worker's profile and the keywords associated with the task. In addition, the crowdsourcing manager 112 can analyze a worker's previous work history, work performance, qualifications, etc. and determine that the worker excels in a specific task area. The crowdsourcing manager 112 can use the keywords associated with a task to ensure that tasks associated with this specific task area(s) are published/advertised to the worker. It should be noted that the crowdsourcing manager 112 can utilize any of the information in the task data 212 for determining which workers to select for notification of a given task.

A fourth column 314, entitled “Type”, comprises entries 316 that identify a task type for the corresponding task. For example, a first entry 316 under this column 314 indicates that Task_1 is a categorization task. Other non-limiting examples of a task type are rank, validate, or moderate. A task type can be manually assigned to a task by or automatically assigned by the task management module 202. A fifth column 318, entitled “Reward”, comprises entries 320 that identify the type and/or amount of reward associated with the corresponding task. For example, a first entry 320 under this column 318 indicates that a worker will receive $0.02 for completing the corresponding task (or completing the corresponding task with the correct output, given amount of time, etc.). The reward can be monetary, merchandise, or any other type of reward selected by the customer. A sixth column 322, entitled “# of Assignments”, comprises entries 324 that indicate a maximum number of workers that can participate in the task, a minimum number of workers that can participate in the task, a current number of workers currently participating in the task, and/or the like. For example, a first entry 324 under this column 322 indicates that the maximum number of unique workers that can participate in the corresponding task is 3. A seventh column 326, entitled “Schedule”, comprises entries 328 that provide optional scheduling information for a corresponding task. Scheduling information can include a task duration (e.g., how long the task is available for), a work duration (e.g., how long a worker has to complete the task), sourcing schedule (e.g., a given date and/or time when the task is to be sourced), and/or the like.

An eighth column 330, entitled “Worker Specs”, comprises entries 332 identifying optional workers qualifications for the corresponding task. These worker specifications/qualifications can be any condition defined by the user that a worker must satisfy prior to being selected for or allowed to participate in a task. These qualifications can be education requirements, age requirements, geographic requirements, previous work history requirements (task or non-task related), previous task work performance, and/or the like. Previous task work performance can include metrics such as an average task completion time, average/number correct results, and/or any other metrics that can be used to represent a worker's work performance. The requirements under this column 330 can be used by the task management module 202 to select/filter workers for participation in the corresponding task. A ninth column 334, entitled “Worker Quality”, comprises entries 336 identifying optional worker quality requirements for the corresponding task. A worker quality requirement identifies a specific quality rating/metric that must be associated with a worker in order for a worker to be selected for or allowed to participate in a task. This worker quality rating/metric is assigned to a worker by the worker management module 208 based various factors such as previous task work performance, duration of association with the crowd sourcing environment, and/or any other factor/metric that allows the worker management module 208 to assign a weight, rating, or metric that represents the overall quality of a worker.

A tenth column 338, entitled “Rules”, comprises entries 340 that include or identify adjudication rules to be applied to the workers' output for a given task. The entries can comprise the actual rules or an identifier/flag that allows the adjudication module 206 to locate the applicable rules (e.g., acceptance criteria) in another table or storage area (not shown). An adjudication rule ensures that the best possible task result(s) is presented to a customer or that a given degree of accuracy and/or confidence can be associated with results provided by workers. For example, an adjudication rule may indicate that additional workers are to be assigned to a task until a given percentage/threshold of workers have provide the (substantially) same task result/solution and use the matching result as the final task result. An adjudication rule provides a way, for example, to determine the correctness of task results/solutions provided by workers.

FIG. 4 shows one example of the worker data 214 maintained by the worker management module 204. It should be noted that although FIG. 4 shows a single table 400 comprising records (i.e., rows) for each worker a separate record/file can be stored for each worker as well. Also, embodiments of the present invention are not limited to a table and other structures for storing data are applicable as well. Even further, one or more columns can be added and/or removed from the table 400 as well. The table 400 in FIG. 4 comprises a plurality of columns and rows, where each row is associated with a single worker. A first column 402, entitled “ID”, comprises entries 404 that uniquely identify a given worker. A second column 406, entitled “Contact Info”, comprises entries 408 including various contact information associated with the corresponding worker. Contact information can include the name, address, phone number, email address, etc. of the worker. A third column 410, entitled “Qualifications”, comprises entries 412 including various qualifications associated with a corresponding worker. Qualifications can be education information, age information, geographic information, work history information (task and non-task related, resume information, previous task work performance information, and/or the like.

A fourth column 414, entitled “Quality Rating”, comprises entries 416 providing quality rating information for the worker. It should be noted that the quality rating/metric can also be included under the “Qualifications” column 410 as well. As discussed above, the quality rating of a worker is assigned to a worker by the worker management module 208 based on various factors such as previous task work performance (e.g., average task completion time, average correct results, etc.), duration of association with the crowd sourcing environment, and/or any other factor/metric that allows the worker management module 208 to assign a weight, rating, or metric that represents the overall quality of a worker. Information under the “Qualifications” column 410 can also be used to determine a quality rating for a given worker. A fifth column 418, entitled “Work History”, comprises entries 420 that include work history information associated with the worker. Work history information can include information such as previous tasks participated in by the worker, current tasks that the worker is participating in, average task completion time, average correct results, statistical information associated with the types of tasks the worker has participated in, and/or the like.

A sixth column 422, entitled “Reward History”, comprises entries 424 including historical reward information. This historical reward information can indicate the overall reward earnings of the worker, average reward earnings per task, average reward earnings per unit of time, and/or any other historical or statistical information associated with rewards earned by the worker. It should be noted that historical reward information can be maintained by the worker management module 208 and/or the reward manager 118 of the reward server 110. A seventh column 426, entitled “Security Credentials”, comprises entries 428 including security information associated with the corresponding worker. Security credentials can include a user name, password, security questions, and/or the like associated with the worker's account with the crowdsourcing server 102. Worker data can also include personal information such as education information, age information, language information, citizenship information, political party information, geographic information, previous work history information (task or non-task related), previous task work performance information, and/or the like.

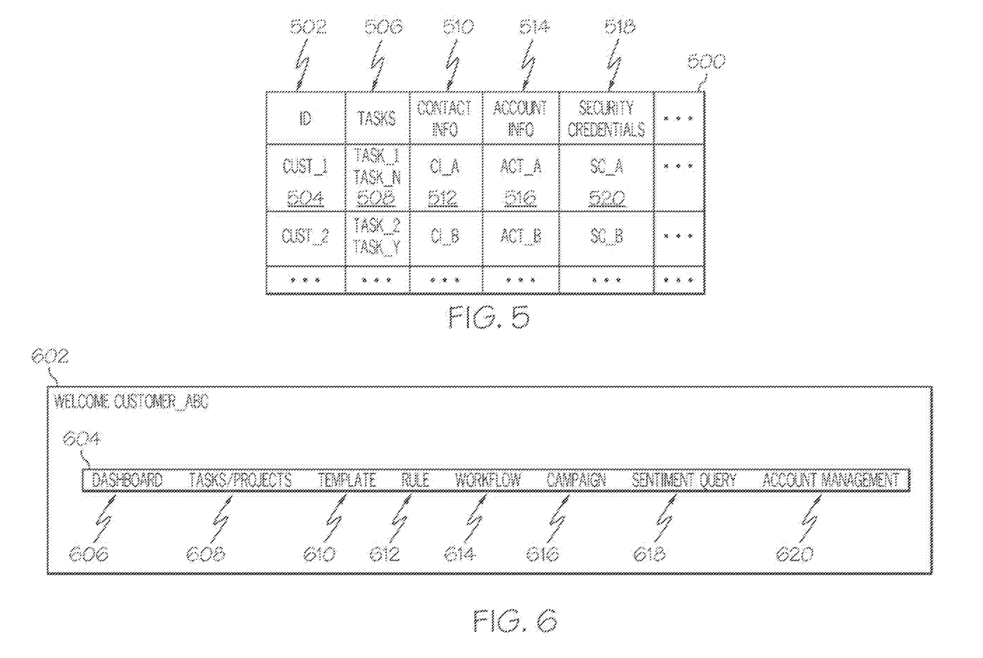

FIG. 5 shows one example of the customer data 216 maintained by the crowd sourcing manager 112. It should be noted that although FIG. 5 shows a single table 500 comprising records (i.e., rows) for each customer a separate record/file can be stored for each customer as well. Also, embodiments of the present invention are not limited to a table and other structures for storing data are applicable as well. Even further, one or more columns can be added and/or removed from the table 500 as well. The table 500 in FIG. 5 comprises a plurality of columns and rows, where each row is associated with a single customer. A first column 502, entitled “ID”, comprises entries 504 that uniquely identify a given customer. A second column 506, entitled “Contact Info”, comprises entries 508 including contact information associated with the corresponding customer. Contact information can include the name, address, phone number, email address, etc. of the customer. A third column 510, entitled “Tasks”, comprise entries 512 that include at least the task ID of each task associated with the customer. These tasks can be previously completed tasks, currently scheduled/sourced tasks, and tasks waiting to be sourced.

A fourth column 514, entitled “Account Info”, comprises entries 516 including the customer's account information for the crowdsourcing server 102. This account information can include payment information if a crowdsourcing environment provided by the server 102 requires a subscription. The account information can also include account balance information for payment of rewards to workers. The account information can further include reward history information such as overall award payouts, payouts to specific workers, average payout per task, and/or the like. A fifth column 518, entitled “Security Credentials”, comprises entries 520 including security information associated with the corresponding customer. Security credentials can include a user name, password, security questions, and/or the like associated with the customer's account with the crowdsourcing server 102.

As discussed above, customers of the crowdsourcing management server 104 interact with the server 104 to create and manage tasks. To create or manage a task, the customer interacts with the crowdsourcing management server 104 via the interface 116 (or programmatically via one or more APIs). In one embodiment, the customer is presented with a log-in screen where the customer can register or provide log-in credentials for accessing the crowdsourcing environment of the server 104. During registration the customer can enter customer information such as desired ID (identifier), password, contact information, payment information (if the crowdsourcing environment requires payment to be used), and the like. This registration is stored in the customer data 216 discussed above with respect to FIG. 5. Once logged-in the customer is presented with various templates/screens based on the desired activity of the customer. These screens are displayed to the customer via a display (not shown) communicatively coupled to the customer system 106. It should be noted that a similar registration process is applicable to workers as well.

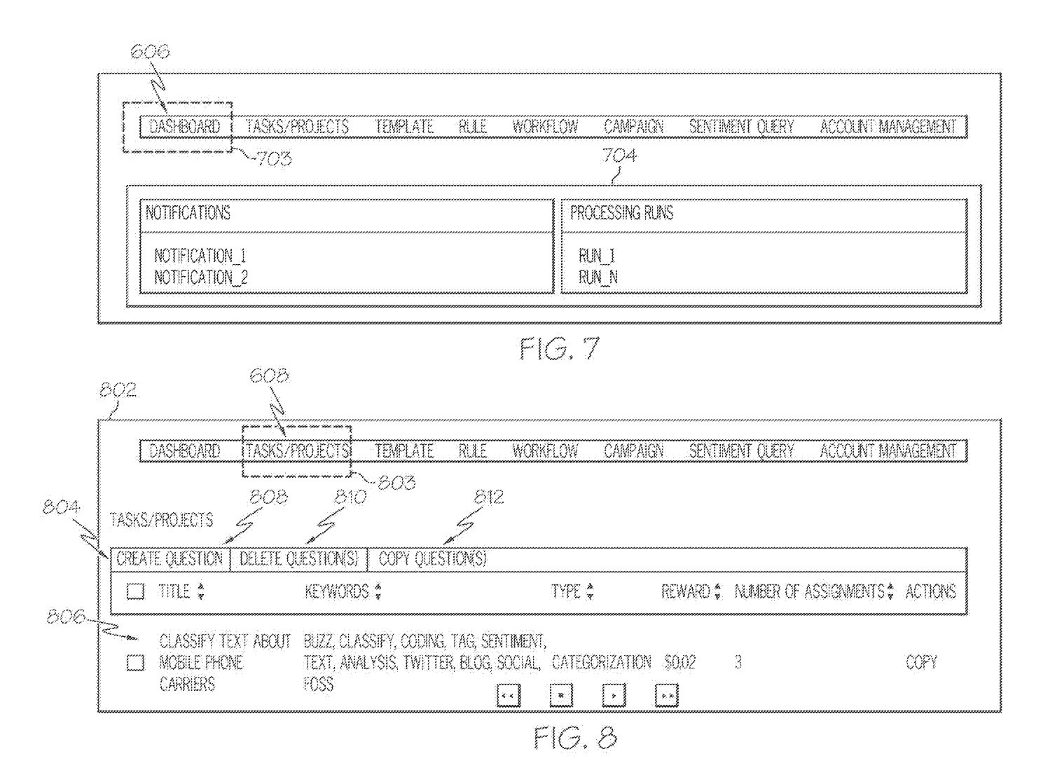

FIG. 6 shows a first screen 602 that can be displayed to the customer after logging into the server 102. This screen 602 comprises a menu 604 that includes various menu items that allow the customer to perform one or more actions. For example, a first menu item 606 allows a customer to view a dashboard or notification area. A second menu item 608 allows the customer to create a task/project to be presented to one or more workers of a crowd environment. A third menu item 610 allows the customer to create or select templates/screens that a worker will interact with when participating in a given task. This menu item 610 allows the customer to specify/create templates/screens that will be displayed to a worker when being notified of a new task/project, acceptance of a task result, and/or rejection of a task result. A fourth menu item 612 allows the customer to select or create adjudication rules for managing workers' task results. A fifth menu item 614 allows a customer to create and manage task workflows from a single task or from multiple tasks. A sixth menu item 616 allows a customer to create and manage workflow campaigns, which are based on interconnected task workflows and their results. A seventh menu item 618 allows a customer to create and manage sentiment campaigns, which comprises tasks related to brand sentiment. An eighth menu item 620 allows the customer manage the customer's account.

FIG. 7 shows one example of a screen(s) presented to the customer, via a user interface, when the customer selects the first menu item 606, as indicated by the dashed box 703. In this example of FIG. 7, the screen 702 comprises a dashboard or notification area 704. This area 704 shows any significant events that are occurring within the system 102. Events such as system failures, paused runs, newly created campaigns, etc. can be displayed to the customer in this area 704. Also, any campaign runs that are currently processing or that are in a paused state can be shown in this area 704 as well.

FIG. 8 shows one example of a screen(s) presented to the customer when the customer has selected the second menu item 608 associated with tasks, as indicated by the dashed box 803. In this example, the user interface comprises one or more screens 802 that comprise a sub-menu 804 and a task display area 806. The sub-menu 804 comprises various actions that the customer can perform with respect to tasks. For example, a first action item 808 allows the customer to create one or more tasks. A second action item 810 allows the customer to delete one or more existing tasks. A third action item 812 allows the customer to copy one or more tasks to more quickly create additional tasks.

The task display area 806 lists the various tasks associated with the customer. These tasks can be current tasks, completed tasks, future tasks, etc. The task display area 806, in one embodiment, can display task information such as title, keywords, task type, reward, number of assignments, and actions. This task information can be retrieved from the task data 212 discussed above. The customer can sort the displayed tasks based on any of the task information presented in the task display area 806.

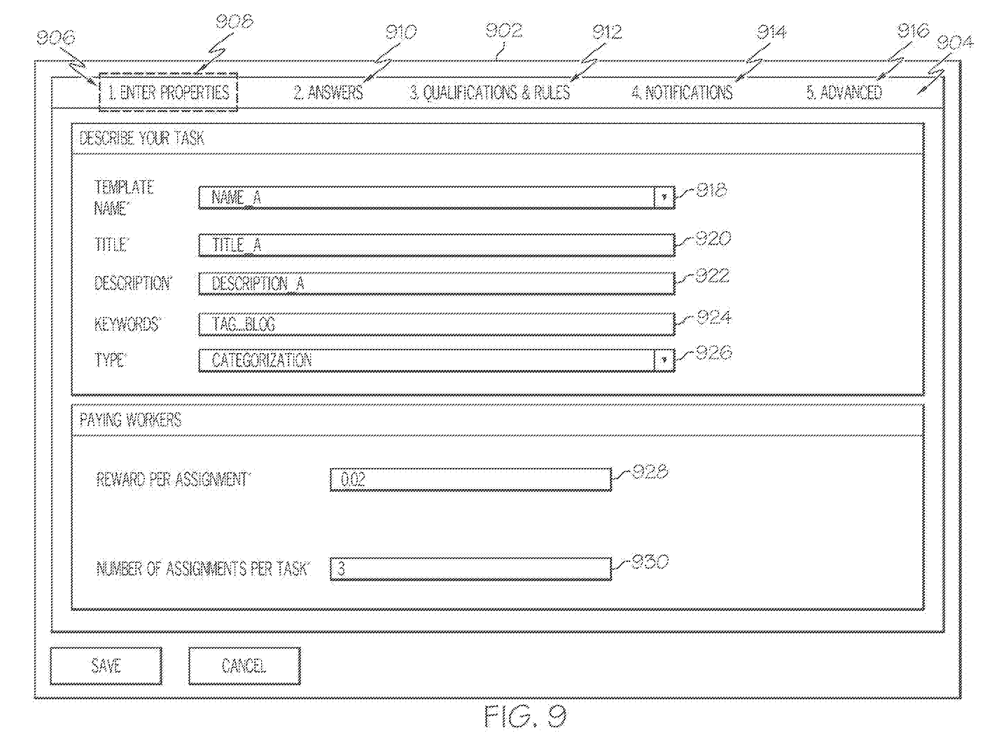

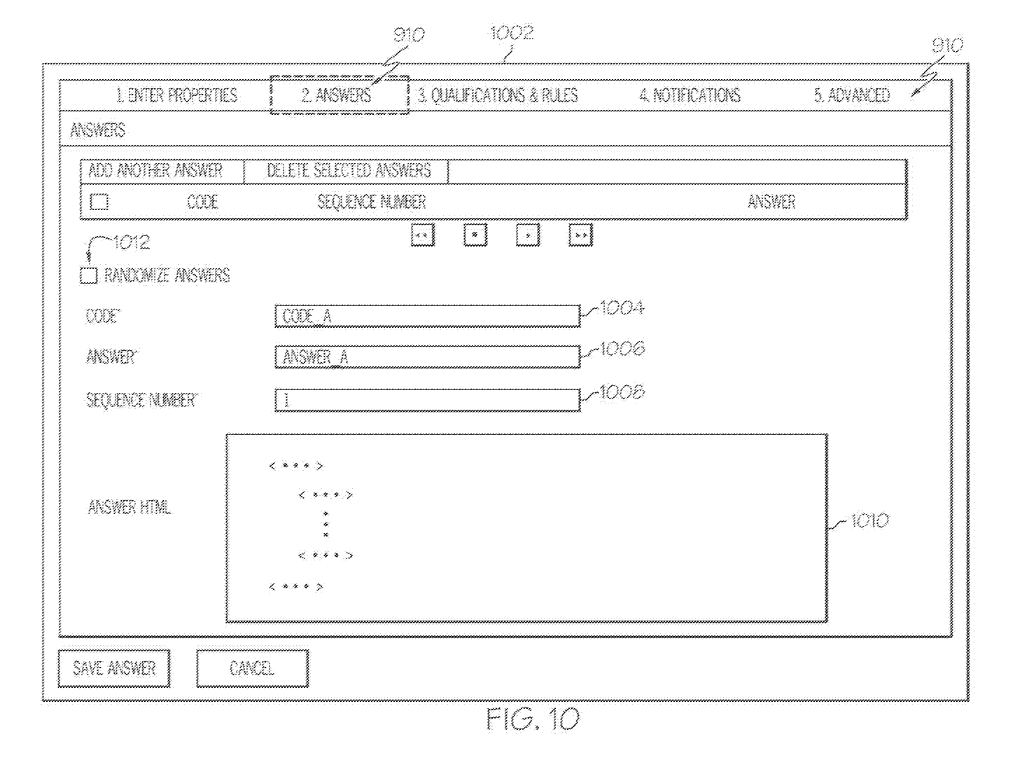

As discussed above, the customer can select an option on the task screen 802 to create/add a task (or project comprising multiple tasks). When the customer selects this option, the template module 204 provides one or more templates to the customer for creating a task(s). FIG. 9 shows a screen 902 comprising a template 904 for creating a task. This template 904 comprises a menu 906 that allows the customer to access various template screens associated with the creation of a task. For example, the customer can select a first set of templates 908 associated with specifying properties of a task, a second set of templates 910 associated with the results/answers to be provided by workers when participating in the task, a third set of templates 912 associated with qualifications and rules of the task, a fourth set of templates 914 associated with notifications for the task, and a fifth set of templates 916 associated with providing advance options for the task. Additional templates can be added as well.

FIG. 9 further shows one example of the first set of templates 908 that is associated with entering properties of a task. This template 908 comprises a first input field 918 that allows the customer to enter and/or select a task name. A second input field 920 allows the customer to enter and/or select a task title. A third input field 922 allows the customer to enter a description of the task. A fourth input field 924 allows the customer to enter a set of keywords to be associated with the task. A fifth input field 926 allows the customer to enter and/or select a task type, such as (but not limited to) Categorization, Rank, Moderation, Validation, etc., that is to be associated with the task. A sixth input field 928 allows the customer to enter and/or select a reward to be given to a worker for completing the task. A seventh input field 930 allows the customer to enter and/or select the maximum and/or minimum number of workers that are allowed to participate in the task or be notified of the task. It should be noted that a customer is not required to provide all of the above information for a task. Once the customer has completed this template the customer can save this information. The task management module 202 stores this information in the task data 212 discussed above.

FIG. 10 shows one example of a screen 1002 displaying the second set of templates 910, which allow the customer to create possible results/answers to a task(s) (or delete previously created results/answers). These results/answers can be used by the adjudication module 206 to validate results/answers received from workers. These results/answers can also be presented to workers to inform them of the results/answers of a task that are expected by the customer. The template 910 of FIG. 10 comprises a first input field 1004 that allows the customer to provide code. The code is used within templates and resulting reports as it represent the values that are used mostly in integration scenarios. For example, Sentiment Answer “Positive” can have codes of “POS” and “P” depending on how customers want to see in their DB. A second input field 1006 allows the customer to provide a result/answer definition. The answer represents what can be visible to the user in case an HTML form (or any other type of form) is not needed. A third input field 1008 allows the customer to specify a sequence number for the result/answer. This sequence number is used by the crowdsourcing manager 112 to display the result/answer in a specific order/position based on the sequence number when there are multiple results/answers. The template 910 also provides an area 1010 that allows the customer to enter code such as (but not limited to) markup language code representing the result/answer. This is used to enhance the user experience for the workers. For example, one can color code the value of Positive to be of green color or value of Negative to be in red. Another example can be Ajax based components that integrate with customer systems for possible display options. Other options such as, but not limited to a randomization option 1012 (for randomizing the order of multiple results/answers when presented to a worker) can also be provided to the customer in this template 910. The task management module 202 associates the result/answer information entered into the template 910 to the given task and can also store this information within the task data 212 as well.

FIG. 11 shows one example of a screen 1102 displaying the third set of templates 912 that are associated with qualifications and rules of the task. A first input field 1104 allows the customer to enter a customized adjudication rule (e.g., acceptance criteria) and/or select from a set of predefined rules. As discussed above, adjudication rules determine the correctness or validity of task results provided by workers. One example of an adjudication rule is as follows: initially assign a task to 4 workers and if 80% of these workers do not agree (i.e., provide the same results) then extend the worker assignment by 1 until an 80% agreement is reached. As can be seen, an adjudication rule can be used to provide the best possible solution to a task or at least provide a given degree of accuracy or confidence of a result to the customer.

A second input field 1106 shown in FIG. 11 allows the customer to create and/or select worker qualifications. These qualifications instruct the worker management module 208 as which workers can be allowed to participate or be notified of the associate task. As discussed above, qualifications can be education requirements, age requirements, language requirements, citizenship requirements, political requirements, geographic requirements, previous work history requirements (task or non-task related), previous task work performance, and/or the like. The task management module 202 stores this information in the task data 212 discussed above.

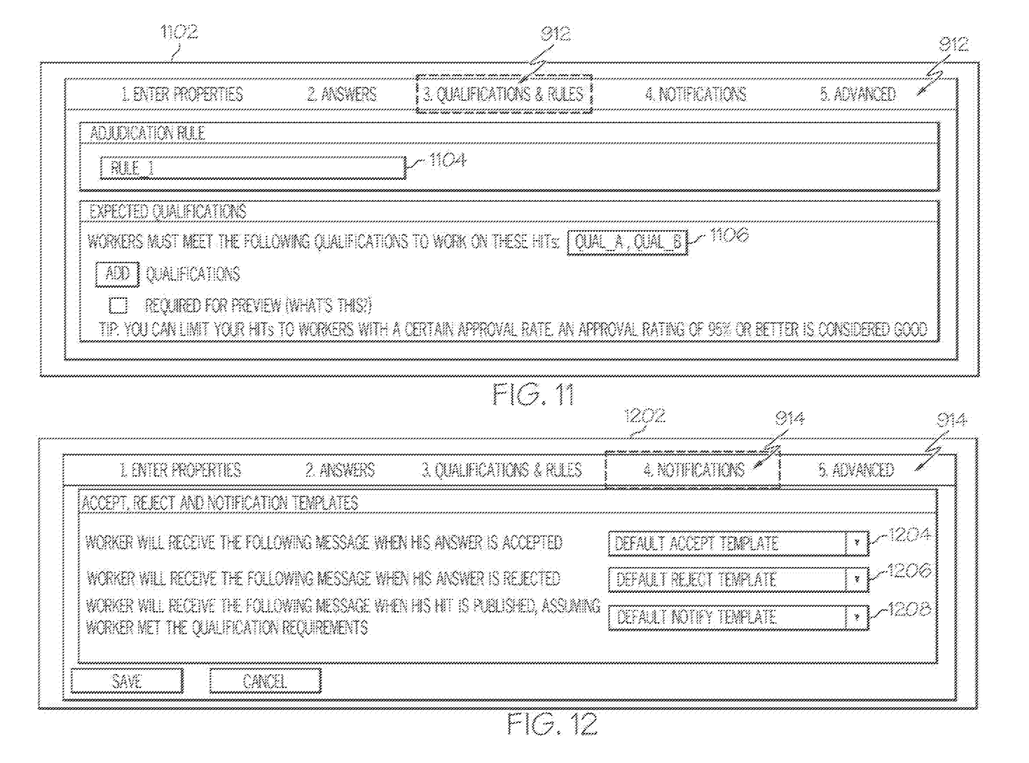

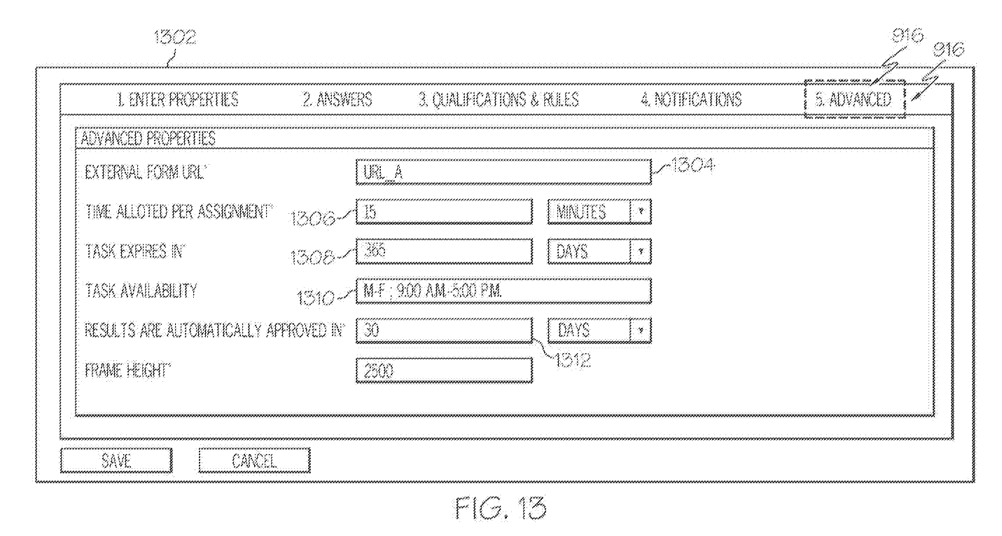

FIG. 12 shows one example of a screen 1202 displaying the fourth set of templates 914 that are associated with task notifications. A first input field 1204 allows the customer to enter and/or select one or more templates/screens to be displayed to a worker when a worker's result/answer is accepted (validated) by the crowdsourcing management server 104. A second input field 1206 allows the customer to enter and/or select one or more templates/screens to be displayed to a worker when a worker's result/answer is rejected (identified as being incorrect) by the crowdsourcing management server 104. A third input field 1208 allows the customer to enter and/or select one or more templates/screens to be displayed to a worker for notifying the worker of a published/sourced task (or project, workflow, campaign, etc.). The task management module 202 stores this information in the task data 212 discussed above.

FIG. 13 shows one example of a screen 1302 displaying the fifth set of templates 916 that allow the customer to enter/select advanced options for a task. A first input field 1304 allows the customer to enter/select an address such as a uniform resource locator to be associated with the task/project. This address is where the task/project is rendered for participation by workers. A second input field 1306 allows the customer to enter/select a time interval for the task/project. This time interval sets a maximum amount of time that a worker has to complete a given task. A third input field 1308 allows the customer to enter/select an amount of time in which the given task or project expires. A fourth input field 1310 allows the customer to specify a period of time during the day/night in which the task is available working on. A fifth input field 1312 allows the customer to specify a given time period in which the crowdsourcing server is to approve a worker's results. This is used for presentation purposes and represents the space allocated on the screen for the Tasks of a specific kind.

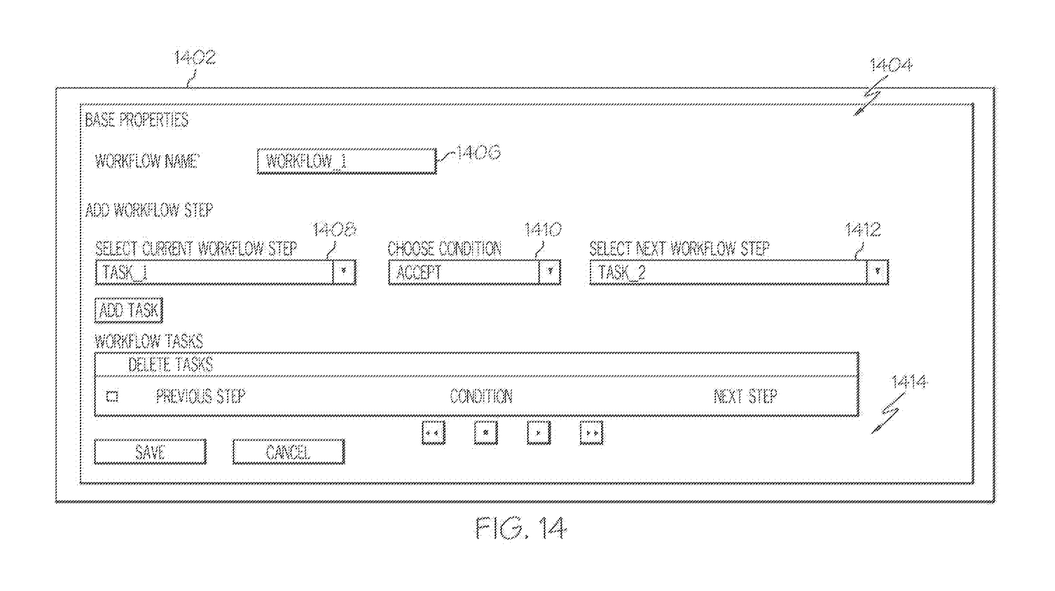

After the customer enters the information discussed above with respect to FIGS. 7-13, the crowdsourcing manager 112 saves this information in the task data 212. The task management module 202 then generates a task or plurality of tasks (e.g., a project) from the information entered by the customer and associates this task with the customer in the customer data 216. In addition to creating a single task or project, a customer can also create various task workflows by selecting the workflow menu item 614 from the menu 604 show in FIG. 6. FIG. 14 shows one example of a screen 1402 comprising a template 1404 that allows the customer to create tasks workflows from a single task or from multiple tasks. In one embodiment, the customer can create micro and macro workflows. A micro workflow takes a set of one or more tasks and couples this set to at least one other set of one or more tasks. In a micro workflow once the worker has generated a result for each task within a first task, the worker moves on to the next set of tasks until the workflow is completed.

A macro workflow or campaign comprises use cases that can be tied together and have intermediate results that can be considered interim between running campaigns. These use cases are customizable based on the response. Stated differently, macro workflow comprises a set of one or more tasks that are coupled to at least one other set of one or more tasks where the results of one set of tasks are used to determine which part of the workflow is presented to the worker next. This allows for breaking a complex task into simpler sub-tasks. The template 1404 shown in FIG. 14 comprises a first input field 1406 that allows the customer to specify a name for a current workflow. A second input field 1408 allows the customer to specify a workflow step. A third input field 1410 allows the customer to specify a condition. A fourth input field 1412 allows the customer to specify the next workflow that is presented to the worker if the condition(s) is satisfied. When interacting with the second input field 1408 or the fourth input field 1412 the customer is presented with tasks or projects that have been previously created by the customer. The customer is able to select a task or project from this list. The customer can then enter or select one or more conditions that need to be met with respect to the selected task(s) in order for the worker to be allowed to advance to the next workflow step specified in the fourth input field 1412. Conditions can include a requirement that the result for the task specified in the second input field 1408 be accepted (validated as being a correct result), a requirement that the result of the task be rejected, etc. Conditions are for workflow splits and joins. For example, conditions are rule based and determine how data is being split into workflow activities and then being combined back into resulting dataset.

The customer is then able to save the information entered into the second, third, and fourth input fields 1408, 1410, and 1412 as a workflow task for the current workflow being created. These workflow tasks can then be displayed to the customer in a display area 1414. A similar process can be performed for creating a macro workflow (e.g., a campaign) where a customer couples workflows together. It should be noted that when a task is selected to be part of a workflow, the task management module 202 updates the task data 212 for this task to reflect its association with the workflow.

In addition the above templates, various other templates (not shown) can be presented to a customer. For example, a set of templates that allows the customer to create or select a template that will be displayed to a worker when participating in a task or as part of a task notification. In these templates, the customer can enter code or provide location information that allows the data integration module 210 to extract customer data from storage for presentation to a worker during task participation. This information can be the data on which the task is to be performed or data that helps the worker perform a task. Another set of templates can be presented to the customer that allows the customer to create and store adjudication rules. A customer can also be presented with a set of templates for creating a sentiment query for a sentiment analysis task. This template allows the customer to specify various web-based information sites or information types, such as (but not limited to) blogs, blog comments, boards, usenet, video, social networking sites, etc., from which to retrieve data from. The customer can provide keywords, language requirements, data requirements, a total number of articles/snippets to retrieve, etc. Based on this information entered by the customer, the crowdsourcing manager 112 retrieves data, such as articles, that are to be presented to a worker as part of a sentiment analysis task.

In addition to the templates and screens discussed above, a customer can also be presented with various reports associated with an individual task, a group of tasks (e.g., a project of tasks), a workflow, campaign, worker, etc. A customer can view reports any time during the life of the task, project, workflow, or campaign or after completion thereof. These reports can include statistical information such as average cost, best and worst task (tasks that require the least amount and most amount of adjudication), best and worst workers, the distribution of answers for questions with fixed answers per run/campaign, the distribution of adjudication scenarios (e.g., 80% were 2 for 2, 20% were 2+1, etc.), etc.

Other examples of information that can be provided in reports is the number of workers that participated in a task (or workflow, campaign, etc.) along with the results provided by the worker; amount of rewards earned by workers per a unit of time; all results submitted by an individual worker or all workers including all results of all tasks of a multi-task project; lifetime worker statistics or statistics for one or more given tasks including accuracy of results (e.g., accuracy measurements such as number of results accepted, number of results rejected, etc.); worker quality rating; worker compensation; worker earnings; worker bonuses; a worker's best/worst qualifications and types of hits (e.g., worker is good at categorization, worker has sub-par performance in address validation, etc.); etc. In addition, a report can be provided to a customer that displays a task(s) to the customer as seen by the workers along with the results provided by workers overlaid thereon.

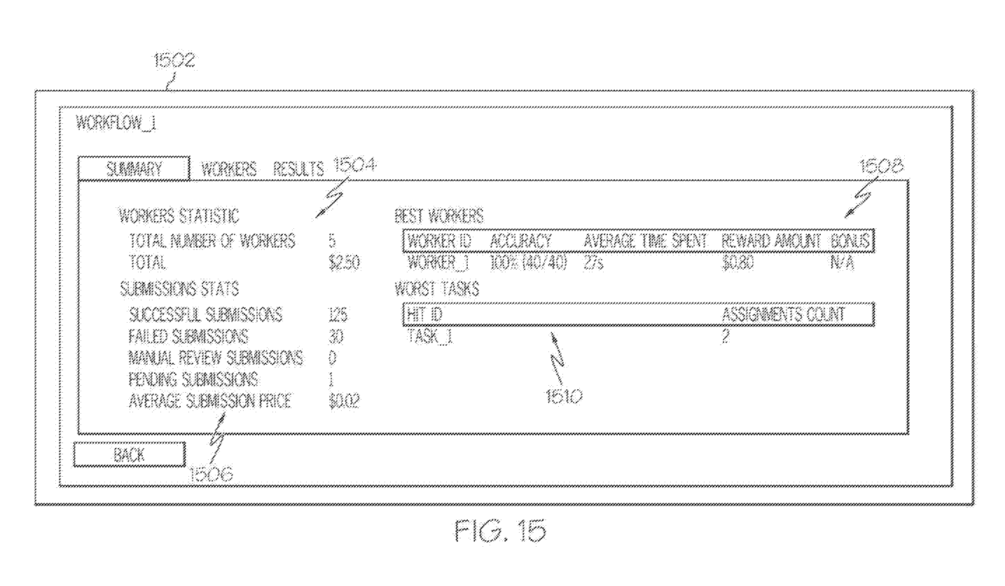

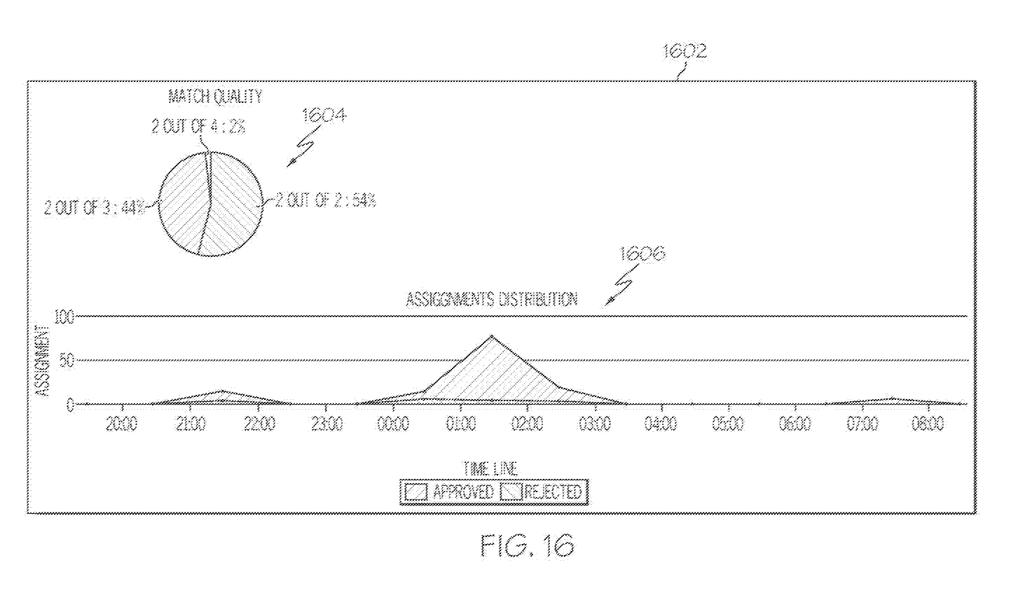

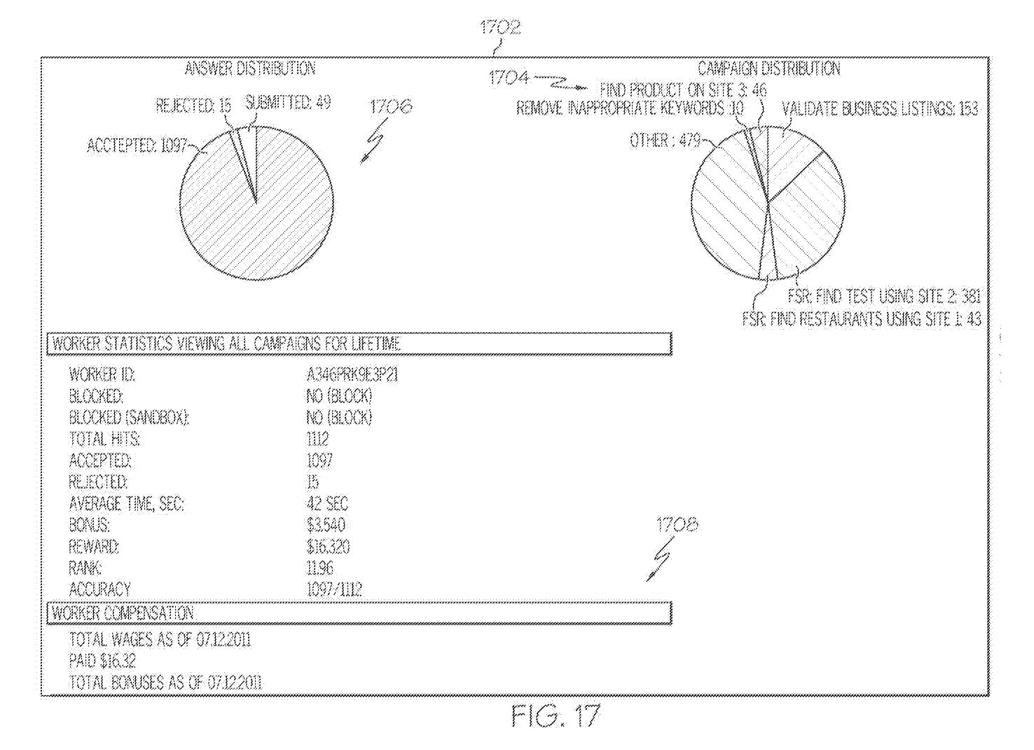

FIG. 15 shows one example of a summary report 1502 for a particular workflow. It should be noted that similar information can be displayed for a single task, project, and/or campaign as well. The report 1502 shown comprises a first area 1504 that displays worker statistics such as the total number workers that participated and the total number of rewards paid out. The report 1502 comprises a second area 1506 that comprises submission data such as the number of successful submissions (e.g., results/answers) by the workers, the number of failed or incorrect submissions, submissions that required manual review by the customer, submissions that are pending approval, and average price per submission (average reward per submission). A third area 1508 lists the best workers (e.g., the top X workers) that participated in the workflow. Information such as worker ID, result/answer accuracy, average time spent per task (average task completion time), reward amount, reward bonus, etc. can be displayed. A fourth area 1510 identifies the best and worst tasks (if applicable) with respect to adjudication processing, result/answer accuracy, time spent to submit a result/answer by workers, etc.

FIG. 16 shows one example of a results report 1602 for a particular workflow. It should be noted that similar information can be displayed for a single task, project, and/or campaign as well. It should also be noted that the formats shown in FIG. 16 for presenting the information are only examples and other formats are applicable as well. The report 1602 shown in FIG. 16 comprises a first area 1604 that provides match quality information. This match quality information shows the percentage of task result submissions that had a 2 out of 2 match, 2 out of 3 match, and 2 out of 4 match. A second area 1606 comprises assignment distribution information. This information shows the number of assignments for the workflow, the time of the assignments, and approval/rejection distribution of the worker response with respect to the number of assignments and assignment time. The results report 1602 can include additional information such as the ID of each task in the workflow; the ID of workers who participated in each of the tasks; the results submitted by the user for each task; the acceptance state (accepted or rejected) of each of these results; information associated with the data on which the corresponding task was performed on; etc.

The match quality portion of FIG. 16 demonstrates plurality distribution. For example, FIG. 16 shows that for 54% of the tasks 2 people were required to find 2 people majority, 44% of the tasks required asking a third worker, and 2% of the tasks required asking 2 workers to achieve a required “2 people agreed on the answer” result. The assignment distribution portion of FIG. 16 shows how workers were performing work over time. For example, FIG. 16 shows a normal bell-curve, which indicates that workers liked the price and task and workers completed the task quickly. This chart can be analyzed for anomalies such as underpriced or erroneous tasks. The match quality chart can be analyzed to determine, for example, if there were too many high assignment cases, e.g., 2 out of 4, as this lowers the confidence in quality results and unnecessarily increases the cost (which can be an indication of poorly constructed tasks or bad quality controls).

FIG. 17 shows one example of a report 1702 for a given worker. This report 1702 can be viewed by the worker or customer. The report 1702 shown in FIG. 17 provides worker information over the lifetime of the worker. Similar reports can be generated for a single task, a group of tasks, a workflow(s), campaign(s), etc. It should also be noted that the formats shown in FIG. 17 for presenting the information are only examples and other formats are applicable as well. This report 1702 comprises a first area 1704 providing answer distribution information. As can be seen from FIG. 17, this worker submitted 49 results that have not been accepted/rejected, submitted 15 results that have been rejected, and has submitted 1097 results that have been accepted by the customer.

A second area 1706 comprises distribution information associated with campaigns, tasks, workflows, etc. In this example, the worker has participated in 43 food service reports (FSR) for finding restaurants using Site_1. The worker has also participated in 381 FSRs for finding restaurants using Site_2. The worker further participated in 153 business listing validation tasks. FIG. 17 also shows that the worker also participated in 46 tasks for finding products on Site_3; 10 tasks for removing inappropriate keywords; and 479 other tasks. A third area 1708 within the report 1702 provides statistical information such as the total number of tasks participated in by the worker, the total number of accepted results, the total number of rejected results, the average time spent on each task, reward bonus information, total reward accumulation, worker rank (e.g., quality rating among other workers), and an accuracy ratio (e.g., the ratio of total number of submitted results and the total number of accepted results.

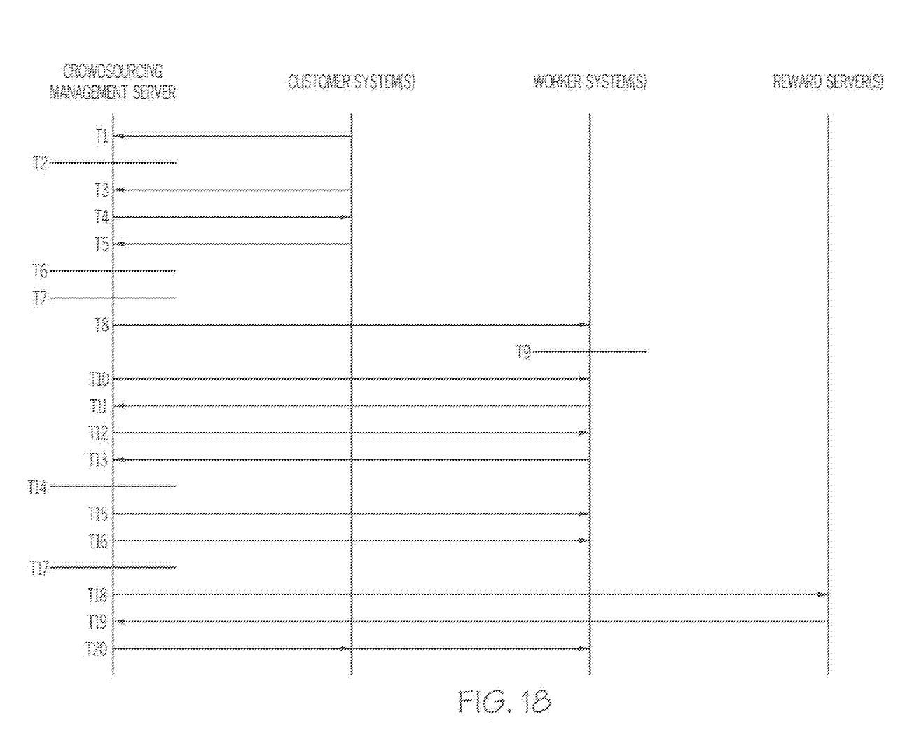

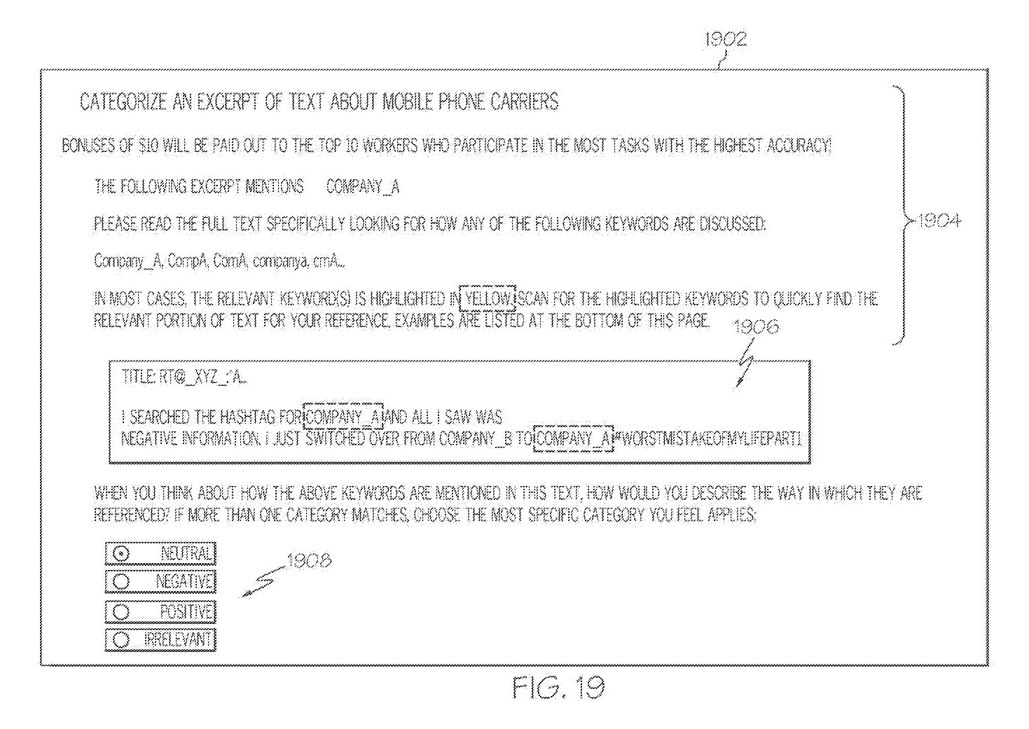

FIG. 18 is a transactional diagram illustrating one example of managing a crowdsourcing environment according to one embodiment of the present invention. It should be noted that embodiments of the present invention are not limited to the sequencing shown in FIG. 18. At T1, a customer at the customer system 106 registers with the crowdsourcing management server 104. At T2, a set of customer data 216 is created for the customer as discussed above with respect to FIG. 5. At T3, the customer selects an option for creating a task. At T4, the template management module 204 of the crowdsourcing manager 112 provides one or more screens/templates to the customer for creating a task. At T5, the customer provides the information requested by the template/screen for creating a task, as discussed above with respect to FIG. 3 and FIGS. 8-13. At T6, the task management module 202 then stores this task information within the task data 212 and generates a task therefrom. At T7, the task management module 202 analyzes the task and associated task data 212 to determine if any worker qualifications/requirements and task requirements are associated therewith. As discussed above, worker qualifications/requirements can indicate, for example, that only workers associated with a given quality rating are to be notified of the given task. Task requirements can be scheduling requirements, requirements regarding the number of workers allowed to participate in the task, etc.

At T8, the task management module 202 publishes/advertises the task (or project, workflow, campaign, etc.) based on the identified worker qualifications/requirements and task requirements. For example, based on the worker qualifications/requirements the worker management module 208 identifies workers that satisfy these qualifications/requirements and notifies the task management module 202 of these identified workers. The task management module 202 proceeds to only notify these workers of the task. Notification can include sending a message (e.g., email, short messaging service message (SMS), instant message, social networking message, etc.) to the selected workers. Notification can also include sending a message to the workers' crowdsourcing account on the server 104 or displaying the task information in a display area for available tasks in one or more screens presented to the workers. It should be noted that if the customer did not specify any worker qualifications/requirements then the task can be sourced to any set of workers. In addition, one or more tasks can be published as an advertising campaign that advertises the task along with its description, requirements, rewards, etc. The advertising campaign can be published using the crowdsourcing environment, a blog, a website, a text message, an email message, and a social media site, and/or the like.

One or more workers receive the notification and logs into his/her account at the server 104, at T9. In another example, the worker does not receive the notification until he/she logs into his/her account at the server 104. At T10, the task management module 202 presents the user with available tasks (e.g., similar to that discussed above with respect to the display area 806 of FIG. 8 for the customer). At T11, the worker selects a task. The crowdsourcing manager 112 provides one or more screens/templates to the worker for performing the actions required by the task, at T12. As discussed above, the template manager 204 generates or retrieves these screens/templates based on the task data 212 associated with the task. When creating a task the customer can select or create a template to be displayed to a worker for working on a task. The customer can also provide datasource information so that the data integration module 210 can retrieve the data for which the worker is to perform the task on.

FIG. 19 shows one example of the screen/template presented to the user for participating in a task. For example, FIG. 19 shows a template 1902 that provides a set of task instructions 1904 identifying the actions to be performed by the user. The template 1902 also provides the data 1906 upon which the actions are to be performed. The worker is also provided with a set of task results 1908 to select based on the data. In the example of FIG. 19, the worker these tasks results are sentiment categories for a brand sentiment.

Returning to FIG. 18, when the worker has completed the task, the worker submits his/her results to the crowdsourcing manager server 104, at T13. AT T14, the adjudication module 206 compares the worker's results for the task to one or more predefined or validated results and/or applies one or more adjudication rules (acceptance criteria) to the worker's results. Based on this process, the adjudication module 206 either accepts or rejects the worker's submission and notifies the worker accordingly, at T15. Depending on the rules setup by the customer, if the worker's submission is rejected, the task management module 202 can optionally assign additional workers to the task, at T16.

At T17, the task management module 202 determines that the task has been completed. This determination can be based on a number or threshold of correct results being received, a time period having expired, an indication from the customer to end the task, etc. At T18, The worker management module 208 identifies all of the workers that submitted a correct result and notifies the reward server 110 to provide the appropriate award to the workers. It should be noted that the workers can be provided their reward as soon as their result is determined to be correct and do not have to wait until the task has deemed completed/ended by the customer or server 102. The reward server 110 can credit a worker's account at the crowdsourcing management server 104, send the reward directly to the worker, or send the reward to a location designated by the worker. At, T20, the crowdsourcing manager 112 sends any applicable reports to the customer and/or the workers, as discussed above.

As can be seen from the above discussion, embodiments of the present invention provide and manage crowdsourcing environments. One or more of these embodiments, allow customers to easily submit task information to a crowdsourcing server. The crowdsourcing server automatically generates a task from this information and manages the data required by the task, worker selection, worker task results, and worker rewards. Therefore, customers are no longer required to manually manage all of this information. This increases quality via an iterative approach as embodiments of the present invention manage the process until a desired accuracy is achieved within allowed budgetary constraints. In addition, embodiments of the present invention leverage previous results to simplify tasks requirements by either allowing workers to choose from already collected data or not asking on data points that have required agreement achieved. For example, two tasks can ask workers to find URL and phone number information for a business. In a first iteration the phone number is identifier but not the URL. Therefore, embodiments of the present invention can dynamically create a task that only asks workers to identify the URL. This reduces complexity and compensation. In another example, a task can ask two or more questions in a single task (find phones for two companies). A first iteration can produce results for one company but not another company. Embodiments of the present invention can then take such fall-outs and create a new task with two companies where agreement was not achieved. Such a process allows for cost reduction since only answers that do not have an agreement are being collected in multi-questions tasks.

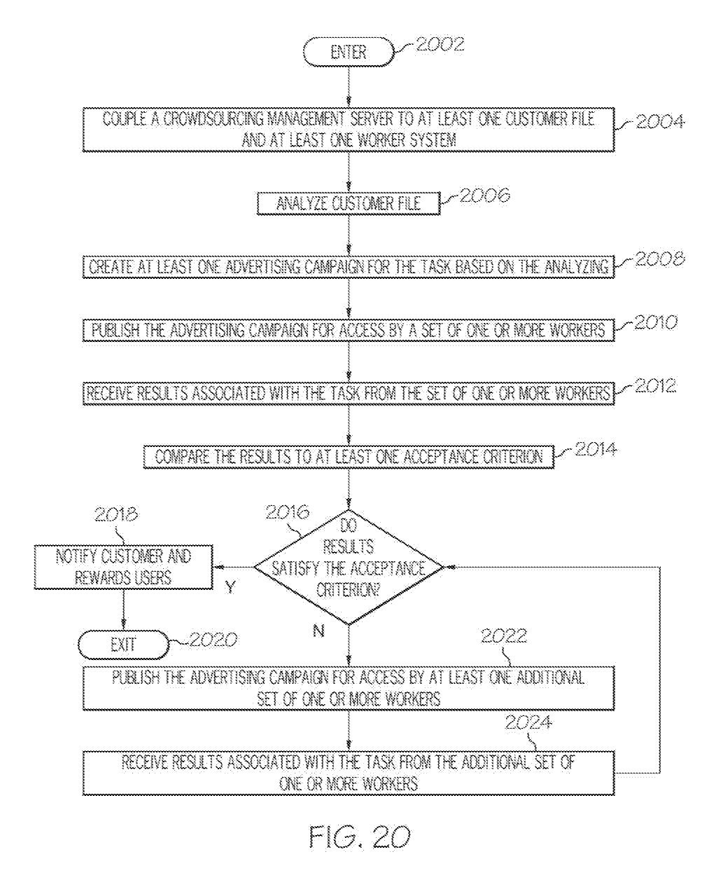

FIG. 20 shows an operational flow diagram illustrating one example of managing a crowdsourcing environment. It should be noted that the steps of the operation flow diagram shown in FIG. 20 have already been discussed above in greater detail. The operational flow diagram of FIG. 20 begins at step 2002 and flows directly to step 2004. A crowdsourcing management server 104, at step 2004, is communicatively coupled over a telecommunications network to at least one customer file (e.g., a database, application, computing system, etc.) and at least one worker system 108. The crowdsourcing management server 104, in one embodiment, is also communicatively coupled to at least one customer system 106 as well. The customer file comprises at least one task to be crowdsourced. The customer file can be one of a database, application, etc. that comprises a task associated with the customer.

A crowdsourcing manager 112 at the server 104, at step 2006, analyzes the customer file to identify at least a description of the task, a reward to be given to workers for completion of the task, and at least one acceptance criterion for accepting the task when completed. This information is provided by the customer and stored within the customer file. This information can also be stored separate from the customer file. Based on this analyzing, the crowdsourcing manager 112, at step 2008, creates at least one advertising campaign for the task. The crowdsourcing manager 112, at step 2010, publishes the advertising campaign for access by a set of one or more workers. It should be noted that after a given period of time, which can be defined by the customer, the advertising campaign can be updated with a new reward that can be offered to the workers. Also, the crowdsourcing manager 112 can determine that a given period of time has passed since the advertising campaign has been published and re-publish the advertising campaign to a new set of one or more worker systems. In one embodiment, this new set of one or more worker systems is larger than the previous set of one or more worker systems.

The crowdsourcing manager 112, at step 2012, receives results associated with the task from the set of one or more workers. The crowdsourcing manager 112, at step 2014, compares the results to the at least one acceptance criterion defined by the customer (or the crowdsourcing manager 112). The crowdsourcing manager 112, at step 2016, determines if the results satisfy the acceptance criterion. If the result of this determination is positive, the crowdsourcing manager 112, at step 2018, notifies the customers of the results and also notifies a reward manager to provide the reward to the workers. The control flow then exits at step 2020. If the result of the determination at step 2016 is negative, the crowdsourcing manager 112, at step 2022, publishes the advertising campaign for access by at least one additional set of one or more workers. The crowdsourcing manager 112, at step 2024, receives results associated with the task from the at least one additional set of one or more workers. The crowdsourcing manager 112 then repeats steps 2016 to 2024 until the acceptance criterion is satisfied by the tasks results submitted by the workers.

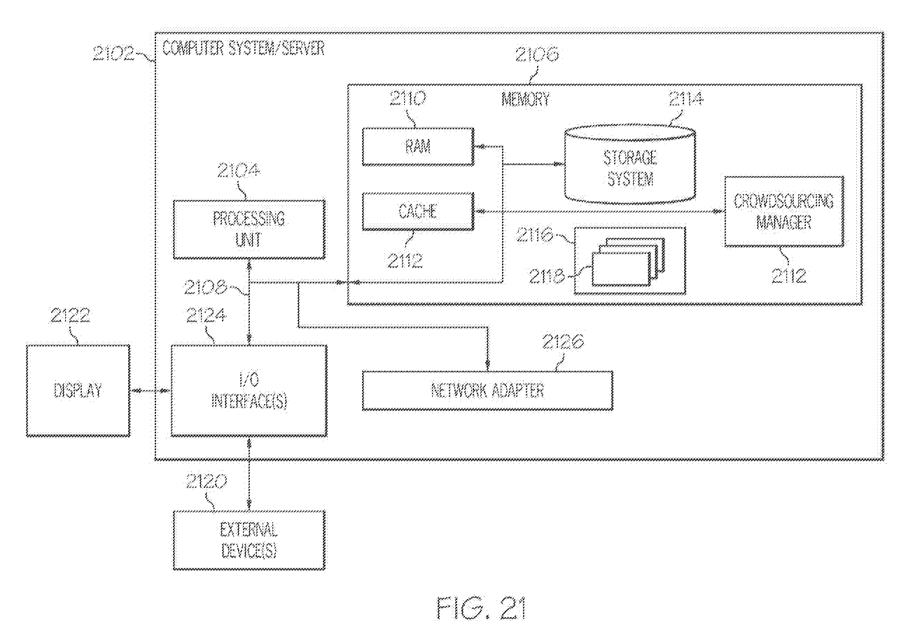

Referring now to FIG. 21, a schematic of an example of an information processing system, such as the server 104 of FIG. 1, is shown. Information processing system 2102 is only one example of a suitable system and is not intended to suggest any limitation as to the scope of use or functionality of embodiments of the invention described herein. Regardless, the information processing system 2102 is capable of being implemented and/or performing any of the functionality set forth hereinabove.

The information processing system 2102 can be a personal computer system, a server computer system, a thin client, a thick client, a hand-held or laptop device, a tablet computing device, a multiprocessor system, a microprocessor-based system, a set top box, a programmable consumer electronic, a network PC, a minicomputer system, a mainframe computer system, a distributed cloud computing system, or the like.

As illustrated in FIG. 21, the information processing system 2102 is shown in the form of a general-purpose computing device. The components of the information processing system 2102 can include, but are not limited to, one or more processors or processing units 2104, a system memory 2106, and a bus 2108 that couples various system components including the system memory 2106 to the processor 2104.

The bus 2108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The information processing system 2102 typically includes a variety of computer system readable media. Such media may be any available media that is accessible by the information processing system 2102, and it includes both volatile and non-volatile media, removable and non-removable media.

The system memory 2106, in one embodiment, comprises the crowdsourcing manager 112, its components, and the various data 212, 214, 216 as shown in FIG. 1. These one or more components can also be implemented in hardware as well. The system memory 2106 can include computer system readable media in the form of volatile memory, such as random access memory (RAM) 1010 and/or cache memory 2112. The information processing system 2102 can further include other removable/non-removable, volatile/non-volatile computer system storage media. By way of example only, a storage system 2114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 2108 by one or more data media interfaces. As will be further depicted and described below, the memory 2106 may include at least one program product having a set (e.g., at least one) of program modules that are configured to carry out the functions of various embodiments of the invention.

Program/utility 2116, having a set (at least one) of program modules 2118, may be stored in memory 2106 by way of example, and not limitation, as well as an operating system, one or more application programs, other program modules, and program data. Each of the operating system, one or more application programs, other program modules, and program data or some combination thereof, may include an implementation of a networking environment. Program modules 2118 generally carry out the functions and/or methodologies of various embodiments of the invention as described herein.

The information processing system 2102 can also communicate with one or more external devices 2120 such as a keyboard, a pointing device, a display 2122, etc.; one or more devices that enable a user to interact with the information processing system 2102; and/or any devices (e.g., network card, modem, etc.) that enable computer system/server 2102 to communicate with one or more other computing devices. Such communication can occur via I/O interfaces 2124. Still yet, the information processing system 2102 can communicate with one or more networks such as a local area network (LAN), a general wide area network (WAN), and/or a public network (e.g., the Internet) via network adapter 2126. As depicted, the network adapter 2126 communicates with the other components of information processing system 2102 via the bus 2108. It should be understood that although not shown, other hardware and/or software components could be used in conjunction with the information processing system 2102. Examples, include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving, by a processor of an information processing system and from a computing device corresponding to at least one customer associated with a task to be crowdsourced, wherein an information set associated with the task comprises at least:
a description of the task;
a reward to be provided for completion of the task; and
at least one adjudication rule for accepting a task result received from a worker system;
identifying a plurality of sub-tasks of the task, wherein the task comprises a workflow having multiple steps, each step in the workflow comprising at least one sub-task;
transmitting, from the information processing system, one or more notifications regarding the task and availability of the reward to a set of one or more worker systems;
receiving, at the information processing system and from at least one of the worker systems in the set, at least one task result associated with one of the sub-tasks;
comparing, by the processor, the task result against the adjudication rule to determine whether the task result conforms to an acceptable degree of accuracy; and
upon assessing satisfaction of the adjudication rule, providing the reward to at least one of the worker systems from which a conforming task result was received.

2. The method of claim 1, further comprising:
selecting worker systems for inclusion in the set, wherein the worker systems are selected for one or more particular sub-tasks of the task.

3. The method of claim 2, wherein the worker systems are selected for a particular one of the sub-tasks based on satisfying one or more qualifications required for the sub-task.

4. The method of claim 3, wherein one of the qualifications specifies one or more keywords, further comprising:
determining that one or more of the specified keywords match one or more keywords in a profile of a worker system; and
adding the worker system to a subset of the set of worker systems, wherein one of the notifications is transmitted only to worker systems in the subset, and wherein the notification describes the sub-task.

5. The method of claim 4, wherein a task result is received for one of the sub-tasks, and wherein a particular one of the at least one adjudication rules corresponds to the sub-task, further comprising:
upon comparing the task result to the particular adjudication rule, determining that the task result does not conform to an acceptable degree of accuracy;
determining that one or more of the specified keywords match one or more keywords in a profile of a new worker system; and
transmitting one or more of the notifications to the new worker system.

6. The method of claim 3, wherein one of the qualifications specifies a quality requirement, further comprising:
determining that a quality metric of a worker system satisfies the quality requirement; and
adding the worker system to a subset of the set of worker systems, wherein one of the notifications is transmitted only to worker systems in the subset, and wherein the notification describes the sub-task.

7. The method of claim 6, wherein the quality metric comprises at least one of:
an accuracy measurement of previous task results received from the worker system;
an average task completion time associated with the worker system; and
performance of the worker system with respect to other worker systems for at least one previous task.

8. The method of claim 6, wherein a task result is received for one of the sub-tasks, and wherein a particular one of the at least one adjudication rules corresponds to the sub-task, further comprising:
upon comparing the task result to the particular adjudication rule, determining that the task result does not conform to an acceptable degree of accuracy;
determining that a quality metric of a new worker system satisfies the quality requirement; and
transmitting one or more of the notifications to the new worker system.

9. The method of claim 1, wherein each of the notifications corresponds to one of the sub-tasks.

10. The method of claim 9, wherein a task result is received for each of the sub-tasks, and wherein a first one of the sub-tasks may only commence once a task result has been received for a second one of the sub-tasks, and wherein the notification corresponding to the first sub-task is transmitted upon receiving the task result for the second sub-task.

11. The method of claim 10, wherein each of the sub-tasks has a corresponding adjudication rule, wherein an assessment of completion for the second sub-task is based on satisfaction of its corresponding adjudication rule, and wherein the first sub-task may only commence once the second sub-task has been assessed as complete, further comprising:
receiving the task result for the second sub-task;
determining that the adjudication rule corresponding to the second sub-task has been satisfied; and
transmitting the notification corresponding to the first sub-task.

12. The method of claim 11, wherein an assessment of completion for the second sub-task is based on satisfaction of its corresponding adjudication rule to an acceptable degree of accuracy, and wherein the adjudication rule is determined to have been satisfied to the acceptable degree of accuracy.

13. The method of claim 1, further comprising:
identifying particular keywords in the description of the task;
determining that one or more of the keywords match keywords in a profile of a new worker system, wherein the advertising campaign has not yet been published to a worker system for the new worker system; and
including the new worker system in the set of worker systems.

14. The method of claim 1, wherein, for at least one of the steps in the workflow, the step is conditioned upon completion of all sub-tasks for a prior step in the workflow.

15. The method of claim 1, wherein, for at least one of the steps in the workflow, commencing the step is conditioned upon acceptance of a task result for at least one sub-task for a prior step in the workflow, wherein the acceptance of the task result is determined based on at least one adjudication rule corresponding to the at least one sub-task.

16. One or more computer-readable non-transitory storage media embodying software comprising instructions operable when executed to:
receive, from a computing device corresponding to at least one customer associated with a task to be crowdsourced, wherein an information set associated with the task comprises at least:
a description of the task;
a reward to be provided for completion of the task; and
at least one adjudication rule for accepting a task result received from a worker system;
identify a plurality of sub-tasks of the task, wherein the task comprises a workflow having multiple steps, each step in the workflow comprising at least one sub-task;
transmit one or more notifications regarding the task and availability of the reward to a set of one or more worker systems;
receive, from at least one of the worker systems in the set, at least one task result associated with one of the sub-tasks;
compare the task result against the adjudication rule to determine whether the task result conforms to an acceptable degree of accuracy; and
upon assessing satisfaction of the adjudication rule, provide the reward to at least one of the worker systems from which a conforming task result was received.

17. The media of claim 16, further comprising:
selecting worker systems for inclusion in the set, wherein the worker systems are selected for one or more particular sub-tasks of the task.

18. The media of claim 17, wherein the worker systems are selected for a particular one of the sub-tasks based on satisfying one or more qualifications required for the sub-task.

19. The media of claim 18, wherein one of the qualifications specifies one or more keywords, further comprising:
determining that one or more of the specified keywords match one or more keywords in a profile of a worker system; and
adding the worker system to a subset of the set of worker systems, wherein one of the notifications is transmitted only to worker systems in the subset, and wherein the notification describes the sub-task.

20. A system comprising one or more processors and a memory coupled to the processors comprising instructions executable by the processors, the processors being operable when executing the instructions to:
receive, from a computing device corresponding to at least one customer associated with a task to be crowdsourced, wherein an information set associated with the task comprises at least:
a description of the task;
a reward to be provided for completion of the task; and
at least one adjudication rule for accepting a task result received from a worker system;
identify a plurality of sub-tasks of the task, wherein the task comprises a workflow having multiple steps, each step in the workflow comprising at least one sub-task;
transmit one or more notifications regarding the task and availability of the reward to a set of one or more worker systems;
receive, from at least one of the worker systems in the set, at least one task result associated with one of the sub-tasks;
compare the task result against the adjudication rule to determine whether the task result conforms to an acceptable degree of accuracy; and
upon assessing satisfaction of the adjudication rule, provide the reward to at least one of the worker systems from which a conforming task result was received.
